(19) United States
(12) Patent Application Publication
(10) Pub. No.: US 2026/0052517 A1
(43) Pub. Date: Feb. 19, 2026

(54) OFF-GRID COMMUNICATION

(71) Applicant: QUALCOMM Incorporated, San Diego, CA (US)

(72) Inventors: Idan Michael HORN, Hod Hasharon (IL); Danlu ZHANG, San Diego, CA (US); Shay LANDIS, Hod Hasharon (IL); Yehonatan DALLAL, Kfar Saba (IL)

(21) Appl. No.: 19/103,820

(22) PCT Filed: Sep. 7, 2023
(86) PCT No.: PCT/US2023/032207

§ 371 Date: Feb. 13, 2025

(30) Foreign Application Priority Data
Sep. 21, 2022 (IL) 296685

(51) Int. Cl. H04W 72/0446

(52) U.S. Cl. CPC H04W 72/0446

(57) ABSTRACT

A UE may identify a set of time-frequency resources for off-slot grid communication with a network node. Similarly, the network node may identify the set of time-frequency resources for off-slot grid communication with a UE. Based on the off-slot grid communication, each of the set of time-frequency resources may be a different time-frequency resource in a different slot. At least two slots may be associated with different durations. The UE and the network node may communicate with each other based on the set of time-frequency resources and the off-slot grid communication. The set of time-frequency resources may correspond to at least one of a time offset in relation to a slot, a frequency offset, a carrier frequency, an SCS, or a bandwidth.

### CROSS-REFERENCE TO RELATED APPLICATION

This application claims the benefit of Israel Patent Application Serial No. 296685, entitled “OFF-GRID COMMUNICATION” and filed on Sep. 21, 2022, which is expressly incorporated by reference herein in its entirety.

### TECHNICAL FIELD

The present disclosure relates generally to communication systems, and more particularly, to security in a wireless communication system based on off-slot grid communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies. In particular, current techniques may not address efficient physical layer authentication between devices in an upcoming wireless communication system where heterogenous new technologies and decentralized network architecture models may be utilized. There may be a need for improved physical layer authentication techniques in a wireless communication system.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be user equipment (UE). The apparatus may identify a set of time-frequency resources for off-slot grid communication with a network node. Based on the off-slot grid communication, each of the set of time-frequency resources may be a different time-frequency resource in a different slot. At least two slots may be associated with different durations. The apparatus may communicate with the network node based on the set of time-frequency resources and the off-slot grid communication.

In an aspect of the disclosure, a method, a computer-readable medium, and an apparatus are provided. The apparatus may be a network node. The apparatus may identify a set of time-frequency resources for off-slot grid communication with a UE. Based on the off-slot grid communication, each of the set of time-frequency resources may be a different time-frequency resource in a different slot. At least two slots may be associated with different durations. The apparatus may communicate with the UE based on the set of time-frequency resources and the off-slot grid communication.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating allocation of time-frequency resources associated with example conventional communications, in accordance with various aspects of the present disclosure.

FIG. 4B is a diagram illustrating allocation of time-frequency resources associated with example off-slot grid communications, in accordance with various aspects of the present disclosure.

FIG. 5 is a diagram of a communication flow of a method of wireless communication, in accordance with various aspects of the present disclosure.

FIG. 6 is a flowchart of a method of wireless communication, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for an example apparatus and/or network entity, in accordance with various aspects of the present disclosure.

FIG. 11 is a diagram illustrating an example of a hardware implementation for an example network entity, in accordance with various aspects of the present disclosure.

### DETAILED DESCRIPTION

Security wireless communication systems, such as 5th generation (5G), 6th generation (6G), or beyond may encompass not just the protection of user data and identities, but also the capability to allow any equipment (e.g., the cloud, the network, and/or the devices) intending to communicate with one another to authenticate each other and authorize the communication so as to protect not just against the unauthorized use of the system, but also against the malicious use of the system.

Some features of upcoming wireless communication systems (e.g., 6G) may present challenges in terms of security. For example, upcoming wireless communication systems may utilize new architecture models that may combine the cloud, the network, and the devices. Further, artificial intelligence (AI)/machine learning (ML) may play a central role in the upcoming wireless communication systems. Moreover, advances in computing may also present security challenges.

The upcoming wireless communication ecosystem may combine a plurality of technologies including cloud technologies, network infrastructure technologies, device technologies, and interfaces between the different technologies. The upcoming wireless communication ecosystem may also feature decentralized network architecture models with a widespread use of edge computing and cellular mesh networks. The new features may potentially create new vulnerabilities when some functions that previously resided in secure areas of the core network are pushed towards the edge of the system. Therefore, various components of the upcoming wireless communication system may natively deliver certain level of security and resilience irrespective of the architecture model used.

In some aspects, physical layer security may provide effective and efficient means against vulnerabilities and threats on the radio medium that may be naturally prone to attacks such as eavesdropping or denial-of-service (i.e., jamming) attacks. In some configurations, the multiple-input-multiple-output (MIMO) beamforming may be exploited in the sub-terahertz (THz) (sub-THz) bands as natural physical layer security to jam potential eavesdroppers.

In one or more configurations, the slot structure (e.g., the actual start/end time of a transmission associated with a slot and/or the bandwidth) may be randomized to improve security. Herein a slot structure may refer to mapping of data to a finite and known (to the transmitter and the receiver) time duration and frequency allocation. For example, in the case of LTE, the slot may occupy half of a subframe and may have a duration of half of a millisecond. The bandwidth of the slot may depend on the band that is used for the slot. In particular, a UE may identify a set of time-frequency resources for off-slot grid communication with a network node. Similarly, the network node may identify the set of time-frequency resources for off-slot grid communication with a UE. The set of time-frequency resources may include different time-frequency resources in different slots. At least two slots may be associated with different durations. The UE and the network node may communicate with each other based on the set of time-frequency resources and the off-slot grid communication. Accordingly, improved physical layer security may be achieved.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

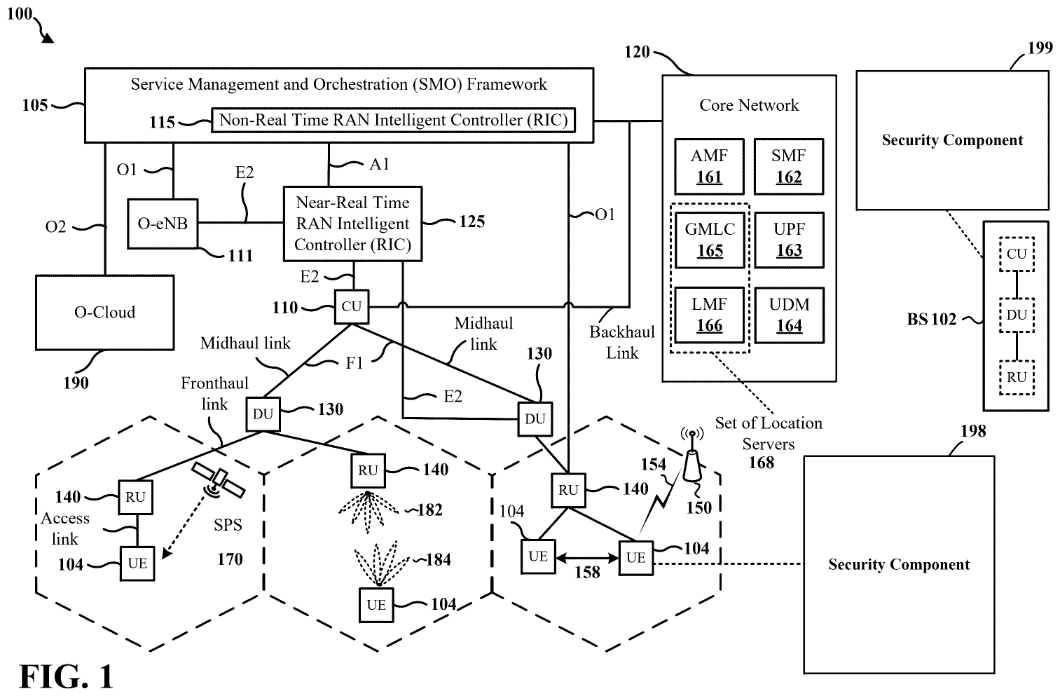

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a security component 198 that may be configured to identify a set of time-frequency resources for off-slot grid communication with a network node. Based on the off-slot grid communication, each of the set of time-frequency resources may be a different time-frequency resource in a different slot. At least two slots may be associated with different durations. The security component 198 may be configured to communicate with the network node based on the set of time-frequency resources and the off-slot grid communication. In certain aspects, the base station 102 may include a security component 199 that may be configured to identify a set of time-frequency resources for off-slot grid communication with a UE. Based on the off-slot grid communication, each of the set of time-frequency resources may be a different time-frequency resource in a different slot. At least two slots may be associated with different durations. The security component 199 may be configured to communicate with the UE based on the set of time-frequency resources and the off-slot grid communication. Although the following description may be focused on 5G NR, 6G, or future generations of wireless communication systems, the concepts described herein may be applicable to other similar areas, such as LTE, LTE-A, CDMA, GSM, and other wireless technologies.

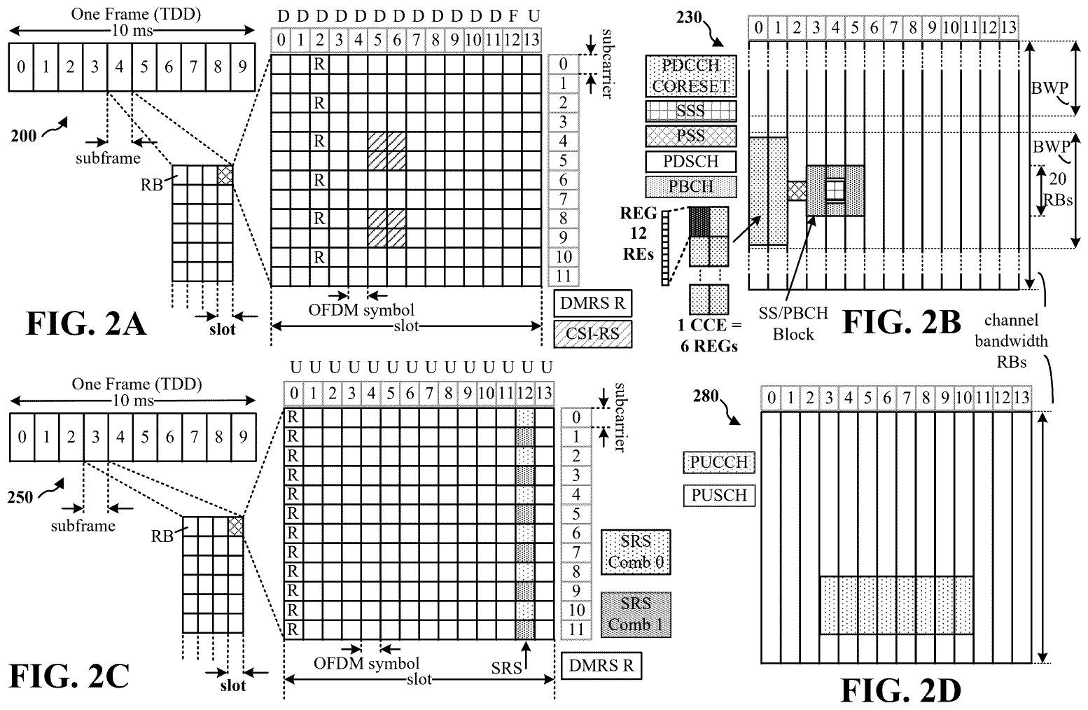

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS (see Table 1).

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

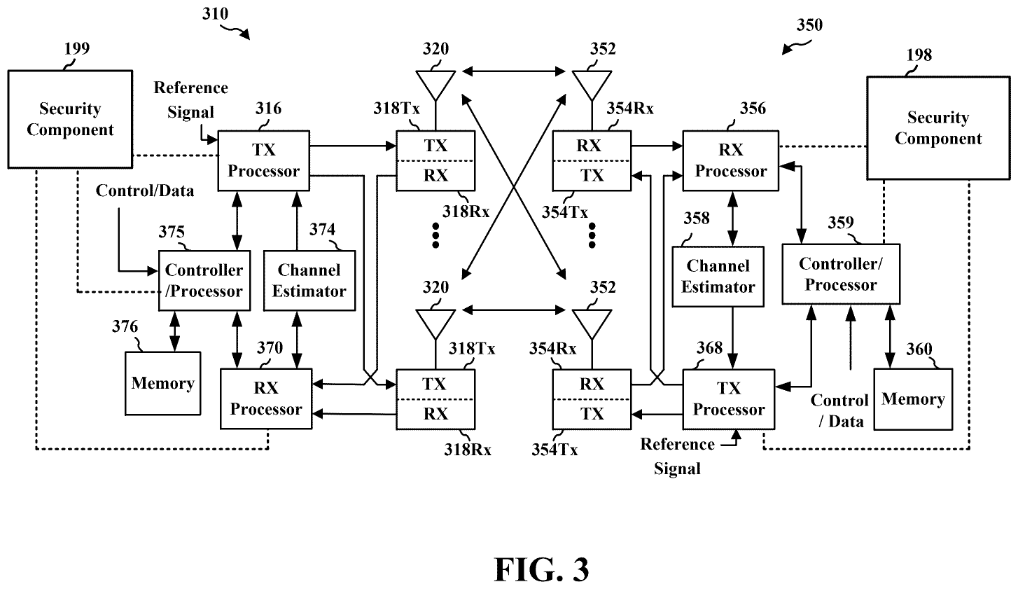

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the security component 198 of FIG. 1.

At least one of the TX processor 316, the RX processor 370, and the controller/processor 375 may be configured to perform aspects in connection with the security component 199 of FIG. 1.

In an upcoming wireless communication system, a radio unit may support multiple streams for communication in the sub-THz bands. The throughput for different use cases such as the fronthaul or even the headset may reach multiple gigabits per second (Gbps). In such a system, time domain waveforms (e.g., for DFT-s-OFDM) and time division multiplexing (TDM)-based communication may be considered, where the TDM-based communication may be used to accommodate multiple UEs. In the TDM-based communication, each UE may have dedicated transmission time periods during which the UE may transmit across the full bandwidth. In such cases, the starting/ending time of each slot may be known. Further, the bandwidth (which may correspond to the SCS and one or more carrier frequency offsets) may be constant. The known starting/ending time of each slot and the constant bandwidth may allow an eavesdropper (e.g., a device performing an eavesdropping attack) to have access to a great amount of data.

Accordingly, in one or more configurations, one or more slots may start (and/or end) at (a) random time instant(s) associated with (a) random timestamp(s). For example, the time instant at which a transmission associated with a slot may start/end may be random. Further, the bandwidth (i.e., the size of the bandwidth) may be randomized. In other words, the SCS and/or one or more carrier frequency offsets may be random. Hereinafter a reference to randomness may also include a reference to pseudo-randomness. A pseudo-random variable may appear random to an outside observer that may not have sufficient information, but may actually be determinative and predictable to insiders that have sufficient information about the pseudo-random variable. Therefore, in other words, the random time instant at which a transmission associated with a slot may start/end and/or the random bandwidth may appear random, unpredictable, and unknowable a priori to an outside observer (e.g., a malicious device, an attacker, etc.). However, for the legitimate transmitter and the legitimate receiver of a communication, the time instant at which a transmission associated with a slot may start/end and the bandwidth may be predictable and identifiable a priori based on one or more preconfigured or pre-exchanged secret parameters or configurations, so that the communication may proceed as intended between the legitimate transmitter and the legitimate receiver. Because the slot structure may be randomized as described herein, the time-frequency resources (e.g., spectrum resources where the frequency is the spectrum of the band and the time is the duration during which the spectrum is used) used for the transmission may not appear to align with the slot grid. Therefore, the communication based on the randomized slot structure may also be referred to as off-(slot) grid communication. Accordingly, the off-(slot) grid communication may correspond to slots located at time occasions that have non-constant periodicity and/or slots allocated in the frequency domain with non-uniform frequency offsets, subcarrier frequencies and/or bandwidths. Further, devices performing off-(slot) grid communication may not be orthogonal to devices communicating using regular OFDM.

In one or more configurations, the (slot structure) randomization may be performed in a discreate or a continuous manner. When the randomization is performed in a continuous manner, there may be an infinite number of possible slot locations (in the time domain) and possible bandwidths/bandwidth locations (in the frequency domain). The large number of randomization possibilities may significantly increase the complexity and difficulty associated with an eavesdropping attack.

Some aspects of the disclosure may be described in relation to a network node (e.g., a base station) and a UE. However, it should be appreciated that the disclosure is not so limited, and the aspects may be adapted to be used with any suitable pair of devices that may communicate with each other over the wireless communication system.

In one or more configurations, at connection establishment, a UE may report (e.g., to a network node) its capability in relation to off-slot grid communication (e.g., whether the UE supports off-slot grid communication). In one or more configurations, the network node may define one or more parameters associated with the off-slot grid communication. The parameters may be described in further detail below. Further, the network node may indicate the parameters to the UE.

In one or more configurations, boundaries or parameters associated with the slot structure randomization may include, e.g., one or more carrier frequency offsets (e.g., the maximum carrier frequency, the minimum carrier frequency), the SCS, and/or one or more slots offsets (e.g., the time offset(s) in relation to the slot grid associated with the actual starting/ending time(s) of the transmission associated with a slot).

In one or more configurations, a randomized parameter associated with the slot structure may be identified based on, e.g., one or more of a radio network temporary identifier (RNTI) of the UE, a slot index, a PBCH index, or one or more key numbers (e.g., (large) prime numbers for security). Further, the randomized parameter associated with the slot structure may be identified based on a preconfigured calculation. For example, a randomized slot structure parameter associated with an initial slot may be determined based on an RNTI of the UE multiplied/divided by the slot index (or PBCH index) and/or one or more key numbers, where the result may further pass through an operator (e.g., a modulo operator or any other suitable operator) with another key number. The output of the modulo operator may be used to determine, e.g., the one or more carrier frequency offsets, the SCS, and/or the one or more slot offsets.

In one or more configurations, before the off-slot grid communication starts, the UE and the network node may securely exchange parameters associated with the off-slot grid communication (e.g., the key numbers). For example, the parameters may be exchanged in the RRC connection establishment message. In one or more other configurations, at least some parameters (e.g., the key numbers) may be predefined and stored at the UE (e.g., in the subscriber identity module (SIM) at the UE).

In one or more configurations, a gap in the time-frequency resources may exist when the randomized slot is located on and compared against the regular slot grid. The transmitting device (e.g., the network node) may transmit dummy samples or dummy subcarriers at the gap so that the gap may be filled with dummy sample or dummy subcarriers. To transmit dummy samples or dummy subcarriers, the transmitting device may transmit power that may not be related to the communication payload (The dummy subcarriers may have similar power as the data subcarriers). The energy corresponding to the dummy samples/subcarriers may be located at time-frequency resources that are different from the time-frequency resources occupied by the off-grid slot. Further, the dummy samples may not map to a constellation as the data subcarriers.

The dummy samples or dummy subcarriers may add to the uncertainty associated with the PDSCH parameters, which may increase the difficulty associated with eavesdropping on the PDSCH. Because the bandwidth parameters may change as the slot index changes (because, e.g., the bandwidth parameters may be determined based on the product of the slot index and one or more key numbers), it may be much more difficult for an eavesdropping attacker to track (follow) where the actual time-frequency resources associated with the PDSCH are and/or to steal/collect data.

For example, for an attacker to learn the slot structure parameters associated with the next slot, the attacker may need to know first the RNTI of the UE, the slot index, and the predefined key numbers. It may be a difficult or impossible task for an attacker to gather all the information. Alternatively, the attacker may search through an almost infinite number of slot structure parameter hypotheses (the number may be large because the slot structure parameter randomization may be associated with a small randomization resolution) in an attempt to find the correct slot structure parameters, which may also be a difficult or impossible task. Accordingly, communication security may be improved. On the other hand, there may be a limit to the reduction of the randomization resolution in some cases because the randomized parameter may not sufficiently disrupt an attacker's ability to decode the transmission if the randomization resolution is not properly selected (i.e., the randomized parameter may become neglectable). For example, if a slot time offset is much smaller than the CP, the attacker may perceive the randomized slot time offset as corresponding to no more than a channel that may be equalized.

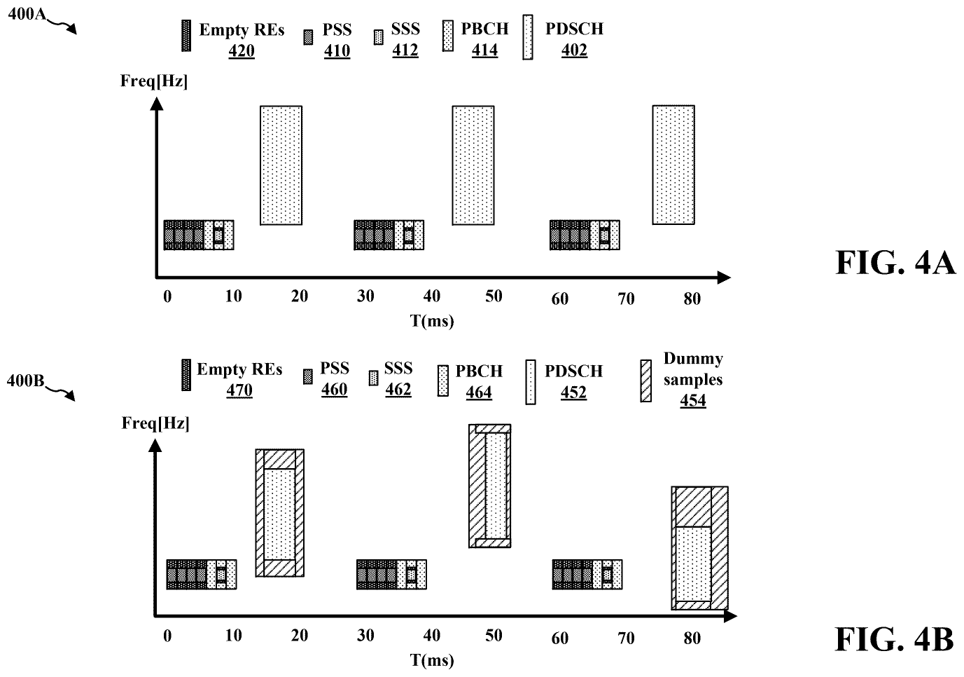

FIG. 4A is a diagram 400A illustrating allocation of time-frequency resources associated with example conventional communications. FIG. 4B is a diagram 400B illustrating allocation of time-frequency resources associated with example off-slot grid communications, in accordance with various aspects of the present disclosure. The allocation of time-frequency resources associated with transmissions of the SSBs (an SSB may include the PSS (e.g., PSS 410 and PSS 460), the SSS (e.g., SSS 412 and SSS 462), and the PBCH (e.g., PBCH 414 and PBCH 464) is illustrated in both FIGS. 4A and 4B. Further, FIGS. 4A and 4B, depict a set of empty REs (e.g., empty REs 420 and empty REs 470). As shown in FIG. 4A, the PDSCHs 402 based on the conventional communication may have a known slot structure (e.g., known time offsets, known carrier frequency offsets, known SCS, etc.). Accordingly, it may not be difficult for an eavesdropping attacker to eavesdrop on the PDSCHs 402 to steal or collect data transmitted therein. In contrast, as shown in FIG. 4B, the PDSCHs 452 based on the off-slot grid communication may have randomized slot structures (e.g., randomized time offsets, randomized carrier frequency offsets, randomized SCSs, etc.). Further, the randomized slot structures may change in different slots. As a result, it may be difficult or impossible for an eavesdropping attacker to eavesdrop on the PDSCHs 452 because the parameters associated with the randomized slot structures may be unpredictable and unknowable a priori to the attacker. Further, as shown in FIG. 4B, the gap in the time-frequency resources between the randomized slots (e.g., the slots corresponding to the PDSCHs 452) and the regular slots corresponding to the regular slot grid may be filled by the transmitting device with dummy samples 454 and/or dummy subcarriers.

In one or more configurations, as TDM-based communication may be used to accommodate multiple UEs and a particular UE may not know which exact slots include data for the UE, the conventional PDCCH procedure may be retained and used, where the UE may search through all the slots and multiple DCI location hypotheses and all the slots. Further, transmissions in different slots may be associated with different randomized bandwidth parameters (e.g., one or more carrier frequency offsets and/or the SCS). In other words, in different slots, the DCIs may be located in different REs.

The overhead associated with the slots structure randomization as described herein may depend on the boundaries or parameters used for the randomization. In general, the wider (higher) the boundaries, the higher the security, because there may be more time-frequency resource locations where the PDSCH may be located. re]

In one or more configurations, overhead of 1 OFDM symbol (which may be much longer than a CP) may be used/incurred. The overhead of 1 OFDM symbol may be affordable in higher bands in an upcoming wireless communication system as the upcoming system in higher bands may enable tremendously high throughputs. Further, the bandwidth overhead incurred by the randomization of the SCS and/or the carrier frequency (Fc) offset may be in the range of a few percentage points.

As described above, a randomized parameter associated with the slot structure may be identified based on, e.g., one or more of an RNTI of the UE, a slot index, a PBCH index, or one or more key numbers (e.g., (large) prime numbers for security). Further, the randomized parameter associated with the slot structure may be identified based on a preconfigured calculation. In one example, the time offset of a starting (initial) time of a PDSCH transmission associated with a slot may be calculated as:

$${t}_{PDSCHinit} = \frac{mod ( {RNTI}_{UE} * \frac{{Prime}_{\#1}}{{Prime}_{\#2}} + slot\_index * \frac{{Prime}_{\#3}}{{Prime}_{\#4}} , {Prime}_{\#5} )}{{Prime}_{\#5}} * ( {tSlot}_{max} - {tSlot}_{min} ) + {tSlot}_{min}$$

where mod( ) may be a modulo operator, tSlotₘₐₓ may be the maximal slot offset, and tSlotₘᵢₙ may be minimal slot offset. Other randomized parameters such as the SCS, the frequency allocation, the carrier frequency offsets, etc., may be calculated similarly.

In one or more configurations, the samples without data (i.e., the samples corresponding to the gap in the time-frequency resources between the randomized slot and the slots based on the regular slot grid) may be filled by the transmitting device with dummy samples (and with different bandwidths).

In one or more configurations, multi-user (MU)-MIMO (MU-MIMO) may be used together with slot structure randomization/off-slot grid communication as described herein because the streams from different UEs may be orthogonal due to the good spatial separation between the UEs in the sub-THz bands. Due to the orthogonality of the streams from different UEs, frequency division multiplexing (FDM) may be used without interference between the UEs. Therefore, MU-MIMO may be used together with slot structure randomization/off-slot grid communication.

Overhead associated with the various aspects described herein may not be negligible, but may be affordable nonetheless because the bandwidth is sufficiently high (e.g., up to 7.5 GHZ) in the sub-THz bands and the system capacity based on the abundant bandwidth may far outpace the specified or desired UE throughput targets.

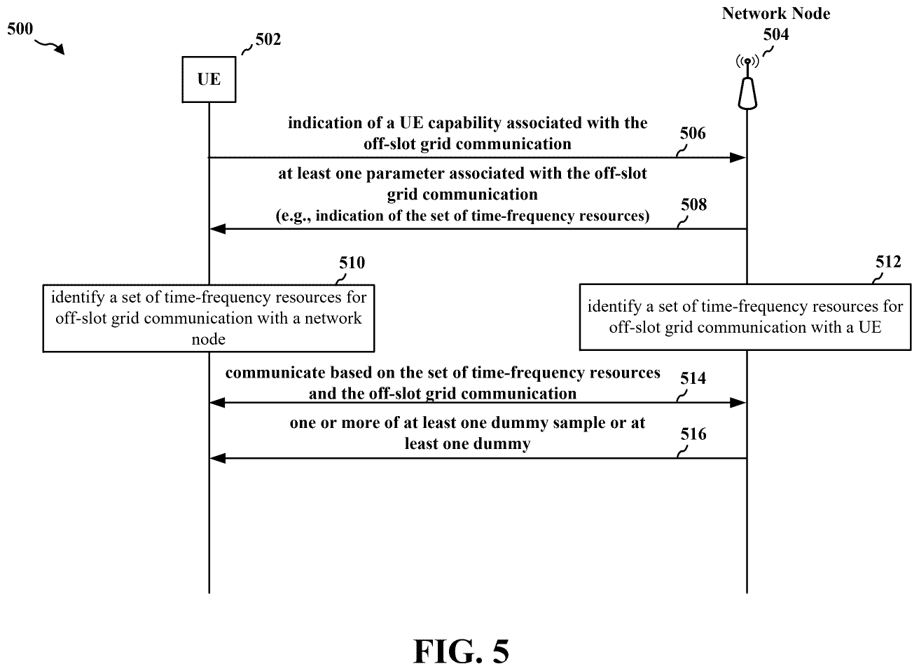

FIG. 5 is a diagram of a communication flow 500 of a method of wireless communication. At 506, the UE 502 may transmit an indication of a UE capability associated with the off-slot grid communication to the network node 504.

At 508, the network node 504 may transmit at least one parameter associated with the off-slot grid communication to the UE 502.

At 510, the UE 502 may identify a set of time-frequency resources for off-slot grid communication with a network node 504. The set of time-frequency resources may include different time-frequency resources in different slots. At least two slots may be associated with different durations.

At 512, the network node 504 may identify a set of time-frequency resources for off-slot grid communication with a UE 502. The set of time-frequency resources may include different time-frequency resources in different slots. At least two slots may be associated with different durations.

In one or more configurations, the set of time-frequency resources may correspond to at least one of a time offset in relation to a slot, a (carrier) frequency offset, a carrier frequency, an SCS, or a bandwidth. In one or more configurations, the set of time-frequency resources may be identified based on at least one of a RNTI of the UE 502, a slot index, a PBCH index, or at least one key number.

In one or more configurations, to identify the set of time-frequency resources at 510, the UE 502 may receive (e.g., at 508), an indication of the set of time-frequency resources from the network node via RRC signaling.

In one or more configurations, the set of time-frequency resources may be preconfigured. A configuration of the set of time-frequency resources may be stored at a SIM at the UE 502. In one or more configurations, the configuration of the set of time-frequency resources may include at least one key number.

At 514, the UE 502 and the network node 504 may communicate with each other based on the set of time-frequency resources and the off-slot grid communication.

In one or more configurations, the communication at 514 may be associated with at least one of a PDSCH or a PDCCH. Therefore, the network node 504 may transmit to the UE 502, and the UE 502 may receive from the network node 504, at least one transmission via at least one of the PDSCH or the PDCCH based on the set of time-frequency resources and the off-slot grid communication.

In one or more configurations, a gap may exist between the set of time-frequency resources and a second set of time-frequency resources corresponding to a slot grid.

At 516, the network node 504 may transmit one or more of at least one dummy sample or at least one dummy subcarrier at the gap between the set of time-frequency resources and a second set of time-frequency resources corresponding to a slot grid.

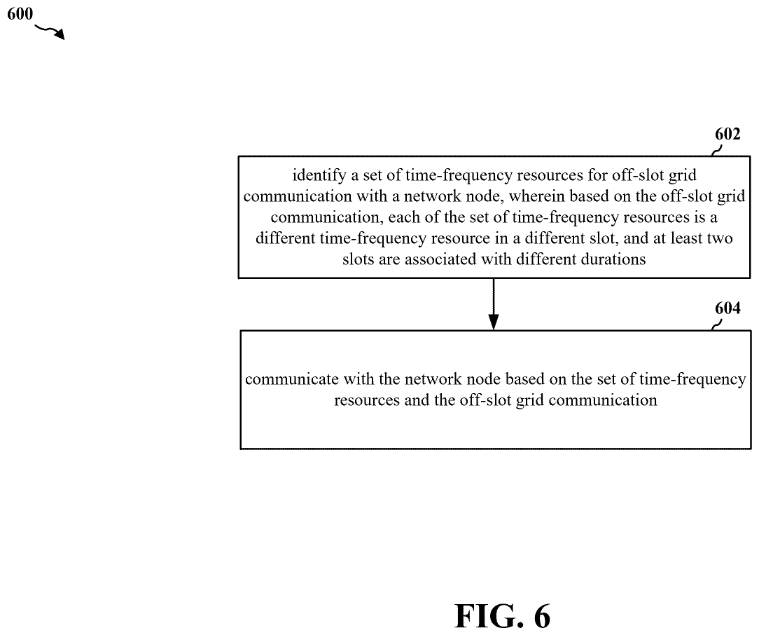

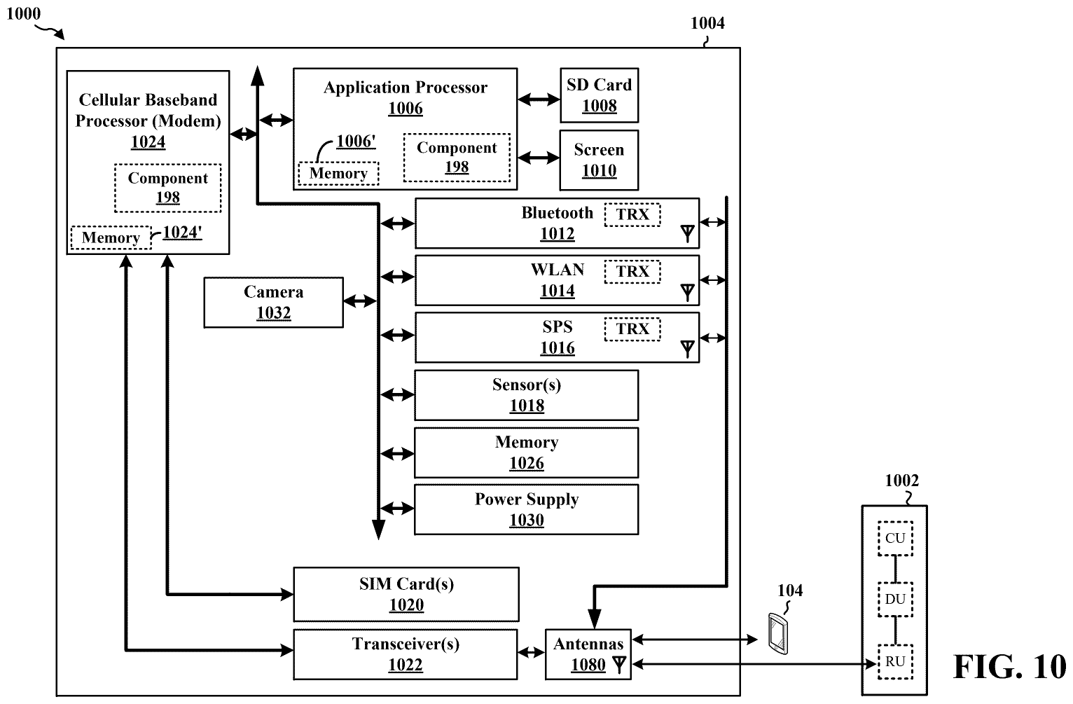

FIG. 6 is a flowchart 600 of a method of wireless communication. The method may be performed by a UE (e.g., the UE 104/350/502; the apparatus 1004). At 602, the UE may identify a set of time-frequency resources for off-slot grid communication with a network node. The set of time-frequency resources may include different time-frequency resources in different slots. At least two slots may be associated with different durations. For example, 602 may be performed by the component 198 in FIG. 10. Referring to FIG. 5, at 510, the UE 502 may identify a set of time-frequency resources for off-slot grid communication with a network node 504.

At 604, the UE may communicate with the network node based on the set of time-frequency resources and the off-slot grid communication. For example, 604 may be performed by the component 198 in FIG. 10. Referring to FIG. 5, at 514, the UE 502 may communicate with the network node 504 based on the set of time-frequency resources and the off-slot grid communication.

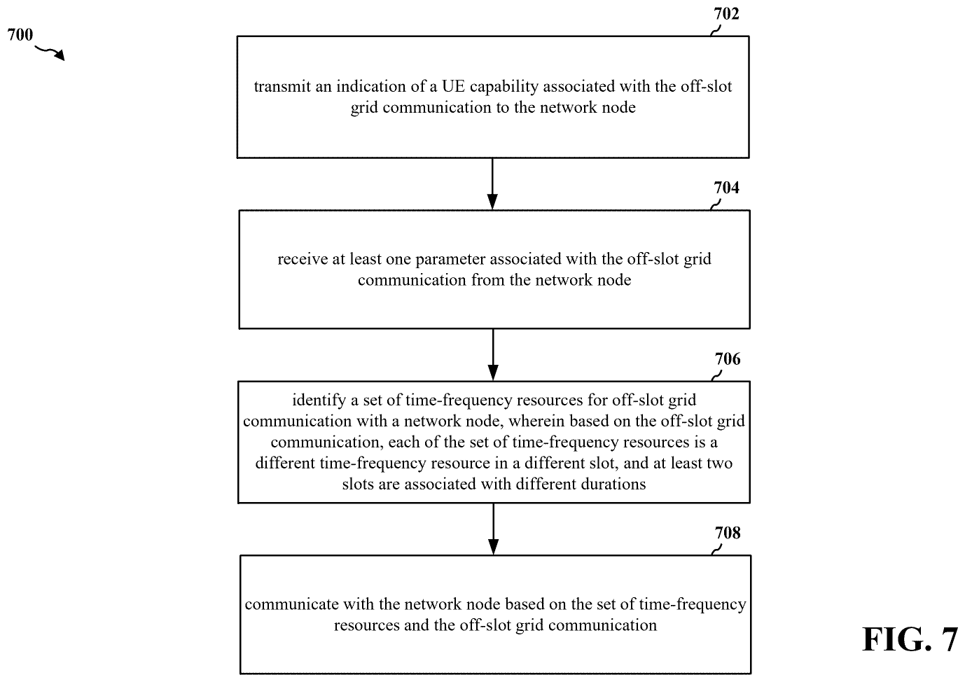

FIG. 7 is a flowchart 700 of a method of wireless communication. The method may be performed by a UE (e.g., the UE 104/350/502; the apparatus 1004). At 706, the UE may identify a set of time-frequency resources for off-slot grid communication with a network node. The set of time-frequency resources may include different time-frequency resources in different slots. At least two slots may be associated with different durations. For example, 706 may be performed by the component 198 in FIG. 10. Referring to FIG. 5, at 510, the UE 502 may identify a set of time-frequency resources for off-slot grid communication with a network node 504.

At 708, the UE may communicate with the network node based on the set of time-frequency resources and the off-slot grid communication. For example, 708 may be performed by the component 198 in FIG. 10. Referring to FIG. 5, at 514, the UE 502 may communicate with the network node 504 based on the set of time-frequency resources and the off-slot grid communication.

In one configuration, the set of time-frequency resources may correspond to at least one of a time offset in relation to a slot, a frequency offset, a carrier frequency, an SCS, or a bandwidth.

In one configuration, referring to FIG. 5, the set of time-frequency resources may be identified based on at least one of a RNTI of the UE 502, a slot index, a PBCH index, or at least one key number.

In one configuration, referring to FIG. 5, to identify the set of time-frequency resources, the UE 502 may receive an indication of the set of time-frequency resources from the network node 504 via RRC signaling. This may be performed as part of 508.

In one configuration, the set of time-frequency resources may be preconfigured. The configuration of the set of time-frequency resources may be stored at a SIM.

In one configuration, the configuration of the set of time-frequency resources may include at least one key number.

In one configuration, referring to FIG. 5, the communication at 514 with the network node 504 may be associated with at least one of a PDSCH or a PDCCH.

In one configuration, referring to FIG. 5, to communicate with the network node 504 based on the set of time-frequency resources, at 514, the UE 502 may receive at least one transmission from the network node 504 via at least one of the PDSCH or the PDCCH based on the set of time-frequency resources.

In one configuration, a gap may exist between the set of time-frequency resources and a second set of time-frequency resources corresponding to a slot grid. The gap may include one or more of at least one dummy sample or at least one dummy subcarrier.

In one configuration, at 702, the UE may transmit an indication of a UE capability associated with the off-slot grid communication to the network node. For example, 702 may be performed by the component 198 in FIG. 10. Referring to FIG. 5, at 506, the UE 502 may transmit an indication of a UE capability associated with the off-slot grid communication to the network node 504.

In one configuration, at 704, the UE may receive at least one parameter associated with the off-slot grid communication from the network node. For example, 704 may be performed by the component 198 in FIG. 10. Referring to FIG. 5, at 508, the UE 502 may receive at least one parameter associated with the off-slot grid communication from the network node 504.

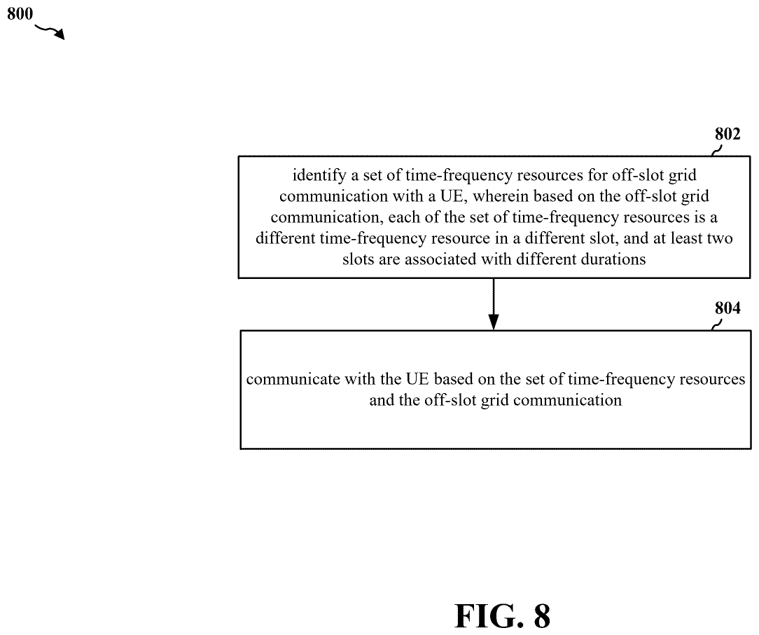

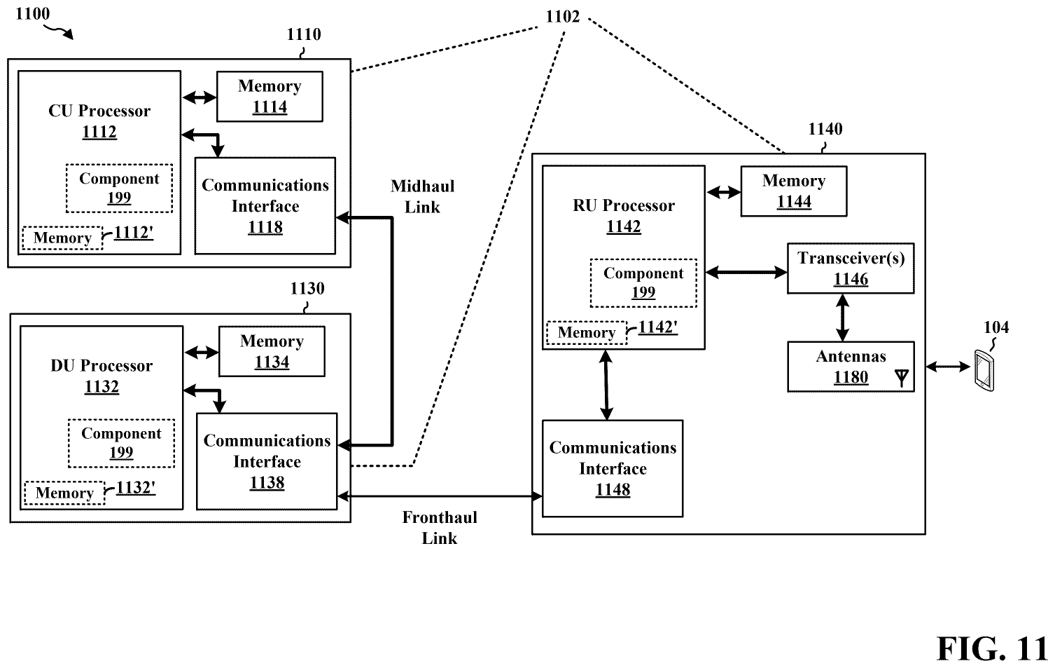

FIG. 8 is a flowchart 800 of a method of wireless communication. The method may be performed by a base station/network node (e.g., the base station 102/310; the network node 504; the network entity 1002). At 802, the network node may identify a set of time-frequency resources for off-slot grid communication with a UE. The set of time-frequency resources may include different time-frequency resources in different slots. At least two slots may be associated with different durations. For example, 802 may be performed by the component 199 in FIG. 11. Referring to FIG. 5, at 512, the network node 504 may identify a set of time-frequency resources for off-slot grid communication with a UE 502.

At 804, the network node may communicate with the UE based on the set of time-frequency resources and the off-slot grid communication. For example, 804 may be performed by the component 199 in FIG. 11. Referring to FIG. 5, at 514, the network node 504 may communicate with the UE 502 based on the set of time-frequency resources and the off-slot grid communication.

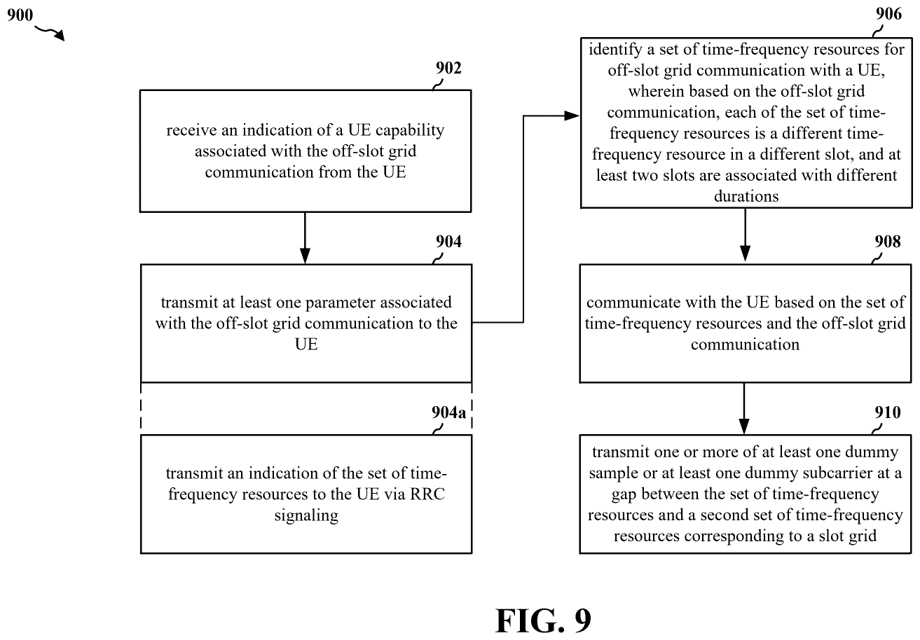

FIG. 9 is a flowchart 900 of a method of wireless communication. The method may be performed by a base station/network node (e.g., the base station 102/310; the network node 504; the network entity 1002). At 906, the network node may identify a set of time-frequency resources for off-slot grid communication with a UE. The set of time-frequency resources may include different time-frequency resources in different slots. At least two slots may be associated with different durations. For example, 906 may be performed by the component 199 in FIG. 11. Referring to FIG. 5, at 512, the network node 504 may identify a set of time-frequency resources for off-slot grid communication with a UE 502.

At 908, the network node may communicate with the UE based on the set of time-frequency resources and the off-slot grid communication. For example, 908 may be performed by the component 199 in FIG. 11. Referring to FIG. 5, at 514, the network node 504 may communicate with the UE 502 based on the set of time-frequency resources and the off-slot grid communication.

In one configuration, the set of time-frequency resources may correspond to at least one of a time offset in relation to a slot, a frequency offset, a carrier frequency, an SCS, or a bandwidth.

In one configuration, referring to FIG. 5, the set of time-frequency resources may be identified based on at least one of a RNTI of the UE 502, a slot index, a PBCH index, or at least one key number.

In one configuration, at 904a, the network node may transmit an indication of the set of time-frequency resources to the UE via RRC signaling. For example, 904a may be performed by the component 199 in FIG. 11. Referring to FIG. 5, at 508, the network node 504 may transmit an indication of the set of time-frequency resources to the UE 502 via RRC signaling.

In one configuration, the set of time-frequency resources may be preconfigured.

In one configuration, referring to FIG. 5, the communication at 514 with the UE 502 may be associated with at least one of a PDSCH or a PDCCH.

In one configuration, referring to FIG. 5, to communicate with the UE 502 based on the set of time-frequency resources, at 514, the network node 504 may transmit at least one transmission to the UE via at least one of the PDSCH or the PDCCH based on the set of time-frequency resources.

In one configuration, at 910, the network node may transmit one or more of at least one dummy sample or at least one dummy subcarrier at a gap between the set of time-frequency resources and a second set of time-frequency resources corresponding to a slot grid. For example, 910 may be performed by the component 199 in FIG. 11. Referring to FIG. 5, at 516, the network node 504 may transmit one or more of at least one dummy sample or at least one dummy subcarrier at a gap between the set of time-frequency resources and a second set of time-frequency resources corresponding to a slot grid.

In one configuration, at 902, the network node may receive an indication of a UE capability associated with the off-slot grid communication from the UE. For example, 902 may be performed by the component 199 in FIG. 11. Referring to FIG. 5, at 506, the network node 504 may receive an indication of a UE capability associated with the off-slot grid communication from the UE 502.

In one configuration, at 904, the network node may transmit at least one parameter associated with the off-slot grid communication to the UE. For example, 904 may be performed by the component 199 in FIG. 11. Referring to FIG. 5, at 508, the network node 504 may transmit at least one parameter associated with the off-slot grid communication to the UE 502.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the component 198 is configured to identify a set of time-frequency resources for off-slot grid communication with a network node. Based on the off-slot grid communication, each of the set of time-frequency resources may be a different time-frequency resource in a different slot. At least two slots may be associated with different durations. The component 198 may be configured to communicate with the network node based on the set of time-frequency resources and the off-slot grid communication. The component 198 may be within the cellular baseband processor 1024, the application processor 1006, or both the cellular baseband processor 1024 and the application processor 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for identifying a set of time-frequency resources for off-slot grid communication with a network node. Based on the off-slot grid communication, each of the set of time-frequency resources may be a different time-frequency resource in a different slot. At least two slots may be associated with different durations. The apparatus 1004, and in particular the cellular baseband processor 1024 and/or the application processor 1006, includes means for communicating with the network node based on the set of time-frequency resources and the off-slot grid communication.

In one configuration, the set of time-frequency resources may correspond to at least one of a time offset in relation to a slot, a frequency offset, a carrier frequency, an SCS, or a bandwidth. In one configuration, the set of time-frequency resources may be identified based on at least one of a RNTI of the UE, a slot index, a PBCH index, or at least one key number. In one configuration, the means for identifying the set of time-frequency resources may be configured to receive an indication of the set of time-frequency resources from the network node via RRC signaling. In one configuration, the set of time-frequency resources may be preconfigured. A configuration of the set of time-frequency resources may be stored at a SIM. In one configuration, the configuration of the set of time-frequency resources may include at least one key number. In one configuration, the communication with the network node may be associated with at least one of a PDSCH or a PDCCH. In one configuration, the means for communicating with the network node based on the set of time-frequency resources may be configured to receive at least one transmission from the network node via at least one of the PDSCH or the PDCCH based on the set of time-frequency resources. In one configuration, a gap may exist between the set of time-frequency resources and a second set of time-frequency resources corresponding to a slot grid. The gap may include one or more of at least one dummy sample or at least one dummy subcarrier. In one configuration, the apparatus 1004, and in particular the cellular baseband processor 1024 and/or the application processor 1006, includes means for transmitting an indication of a UE capability associated with the off-slot grid communication to the network node. In one configuration, the apparatus 1004, and in particular the cellular baseband processor 1024 and/or the application processor 1006, includes means for receiving at least one parameter associated with the off-slot grid communication from the network node.

The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra.

The computer-readable medium/memory may also be used for storing data that is manipulated by the processor(s) when executing software.

As discussed supra, the component 199 is configured to identify a set of time-frequency resources for off-slot grid communication with a UE. Based on the off-slot grid communication, each of the set of time-frequency resources may be a different time-frequency resource in a different slot. At least two slots may be associated with different durations. The component 199 is configured to communicate with the UE based on the set of time-frequency resources and the off-slot grid communication. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for identifying a set of time-frequency resources for off-slot grid communication with a UE. Based on the off-slot grid communication, each of the set of time-frequency resources may be a different time-frequency resource in a different slot. At least two slots may be associated with different durations. The network entity 1102 includes means for communicating with the UE based on the set of time-frequency resources and the off-slot grid communication.

In one configuration, the set of time-frequency resources may correspond to at least one of a time offset in relation to a slot, a frequency offset, a carrier frequency, an SCS, or a bandwidth. In one configuration, the set of time-frequency resources may be identified based on at least one of a RNTI of the UE, a slot index, a PBCH index, or at least one key number. In one configuration, the network entity 1102 includes means for transmitting an indication of the set of time-frequency resources to the UE via RRC signaling. In one configuration, the set of time-frequency resources may be preconfigured. In one configuration, the communication with the UE may be associated with at least one of a PDSCH or a PDCCH. In one configuration, the means for communicating with the UE based on the set of time-frequency resources may be configured to transmit at least one transmission to the UE via at least one of the PDSCH or the PDCCH based on the set of time-frequency resources. In one configuration, the network entity 1102 includes means for transmitting one or more of at least one dummy sample or at least one dummy subcarrier at a gap between the set of time-frequency resources and a second set of time-frequency resources corresponding to a slot grid. In one configuration, the network entity 1102 includes means for receiving an indication of a UE capability associated with the off-slot grid communication from the UE. In one configuration, the network entity 1102 includes means for transmitting at least one parameter associated with the off-slot grid communication to the UE.

The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

Referring back to FIGS. 4-11, a UE may identify a set of time-frequency resources for off-slot grid communication with a network node. Similarly, the network node may identify the set of time-frequency resources for off-slot grid communication with a UE. Based on the off-slot grid communication, the set of time-frequency resources may include different time-frequency resources in different slots. At least two slots may be associated with different durations. The UE and the network node may communicate with each other based on the set of time-frequency resources and the off-slot grid communication. Accordingly, improved physical layer security may be achieved. Further, the improved system may be backward compatible because the slot structure randomization may be disabled if the other device in the communication does not support the randomized slot structure.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including identifying a set of time-frequency resources for off-slot grid communication with a network node, wherein based on the off-slot grid communication, each of the set of time-frequency resources is a different time-frequency resource in a different slot, and at least two slots are associated with different durations; and communicating with the network node based on the set of time-frequency resources and the off-slot grid communication.

Aspect 2 is the method of aspect 1, where the set of time-frequency resources corresponds to at least one of a time offset in relation to a slot, a frequency offset, a carrier frequency, an SCS, or a bandwidth.

Aspect 3 is the method of any of aspects 1 and 2, where the set of time-frequency resources is identified based on at least one of a RNTI of the UE, a slot index, a PBCH index, or at least one key number.

Aspect 4 is the method of any of aspects 1 to 3, where identifying the set of time-frequency resources includes receiving an indication of the set of time-frequency resources from the network node via RRC signaling.

Aspect 5 is the method of any of aspects 1 to 3, where the set of time-frequency resources is preconfigured, and a configuration of the set of time-frequency resources is stored at a SIM.

Aspect 6 is the method of aspect 5, where the configuration of the set of time-frequency resources includes at least one key number.

Aspect 7 is the method of any of aspects 1 to 6, where the communication with the network node is associated with at least one of a PDSCH or a PDCCH.

Aspect 8 is the method of aspect 7, where communicating with the network node based on the set of time-frequency resources includes receiving at least one transmission from the network node via at least one of the PDSCH or the PDCCH based on the set of time-frequency resources.

Aspect 9 is the method of any of aspects 1 to 8, where a gap exists between the set of time-frequency resources and a second set of time-frequency resources corresponding to a slot grid, and the gap includes one or more of at least one dummy sample or at least one dummy subcarrier.

Aspect 10 is the method of any of aspects 1 to 9, further including: transmitting an indication of a UE capability associated with the off-slot grid communication to the network node.

Aspect 11 is the method of any of aspects 1 to 10, further including: receiving at least one parameter associated with the off-slot grid communication from the network node.

Aspect 12 is a method of wireless communication at a network node, including identifying a set of time-frequency resources for off-slot grid communication with a UE, wherein based on the off-slot grid communication, each of the set of time-frequency resources is a different time-frequency resource in a different slot, and at least two slots are associated with different durations; and communicating with the UE based on the set of time-frequency resources and the off-slot grid communication.

Aspect 13 is the method of aspect 12, where the set of time-frequency resources corresponds to at least one of a time offset in relation to a slot, a frequency offset, a carrier frequency, an SCS, or a bandwidth.

Aspect 14 is the method of any of aspects 12 and 13, where the set of time-frequency resources is identified based on at least one of a RNTI of the UE, a slot index, a PBCH index, or at least one key number.

Aspect 15 is the method of any of aspects 12 to 14, further including: transmitting an indication of the set of time-frequency resources to the UE via RRC signaling.

Aspect 16 is the method of any of aspects 12 to 14, where the set of time-frequency resources is preconfigured.

Aspect 17 is the method of any of aspects 12 to 16, where the communication with the UE is associated with at least one of a PDSCH or a PDCCH.

Aspect 18 is the method of aspect 17, where communicating with the UE based on the set of time-frequency resources includes transmitting at least one transmission to the UE via at least one of the PDSCH or the PDCCH based on the set of time-frequency resources.

Aspect 19 is the method of any of aspects 12 to 18, further including: transmitting one or more of at least one dummy sample or at least one dummy subcarrier at a gap between the set of time-frequency resources and a second set of time-frequency resources corresponding to a slot grid.

Aspect 20 is the method of any of aspects 12 to 19, further including: receiving an indication of a UE capability associated with the off-slot grid communication from the UE.

Aspect 21 is the method of any of aspects 12 to 20, further including: transmitting at least one parameter associated with the off-slot grid communication to the UE.

Aspect 22 is an apparatus for wireless communication including at least one processor coupled to a memory and, based at least in part on information stored in the memory, the at least one processor is configured to implement a method as in any of aspects 1 to 21.

Aspect 23 may be combined with aspect 22 and further includes a transceiver coupled to the at least one processor.

Aspect 24 is an apparatus for wireless communication including means for implementing any of aspects 1 to 21.

Aspect 25 is a non-transitory computer-readable storage medium storing computer executable code, where the code when executed by a processor causes the processor to implement any of aspects 1 to 21.

Various aspects have been described herein. These and other aspects are within the scope of the following claims.

1. An apparatus for wireless communication at a user equipment (UE), comprising:
a memory; and
at least one processor coupled to the memory and, based at least in part on information stored in the memory, the at least one processor is configured to:
identify a set of time-frequency resources for off-slot grid communication with a network node, wherein based on the off-slot grid communication, each of the set of time-frequency resources is a different time-frequency resource in a different slot, and at least two slots are associated with different durations; and
communicate with the network node based on the set of time-frequency resources and the off-slot grid communication.

2. The apparatus of claim 1, wherein the set of time-frequency resources corresponds to at least one of a time offset in relation to a slot, a frequency offset, a carrier frequency, a subcarrier spacing (SCS), or a bandwidth.

3. The apparatus of claim 1, wherein the set of time-frequency resources is identified based on at least one of a radio network temporary identifier (RNTI) of the UE, a slot index, a physical broadcast channel (PBCH) index, or at least one key number.

4. The apparatus of claim 1, wherein to identify the set of time-frequency resources, the at least one processor is configured to receive an indication of the set of time-frequency resources from the network node via radio resource control (RRC) signaling.

5. The apparatus of claim 1, wherein the set of time-frequency resources is preconfigured, and a configuration of the set of time-frequency resources is stored at a subscriber identity module (SIM).

6. The apparatus of claim 5, wherein the configuration of the set of time-frequency resources includes at least one key number.

7. The apparatus of claim 1, wherein the communication with the network node is associated with at least one of a physical downlink shared channel (PDSCH) or a physical downlink control channel (PDCCH).

8. The apparatus of claim 7, wherein to communicate with the network node based on the set of time-frequency resources, the at least one processor is configured to receive at least one transmission from the network node via at least one of the PDSCH or the PDCCH based on the set of time-frequency resources.

9. The apparatus of claim 1, wherein a gap exists between the set of time-frequency resources and a second set of time-frequency resources corresponding to a slot grid, and the gap includes one or more of at least one dummy sample or at least one dummy subcarrier.

10. The apparatus of claim 1, the at least one processor being further configured to:
transmit an indication of a UE capability associated with the off-slot grid communication to the network node.

11. The apparatus of claim 1, the at least one processor being further configured to:
receive at least one parameter associated with the off-slot grid communication from the network node.

12. The apparatus of claim 1, further comprising a transceiver coupled to the at least one processor.

13. A method of wireless communication at a user equipment (UE), comprising:
identifying a set of time-frequency resources for off-slot grid communication with a network node, wherein based on the off-slot grid communication, each of the set of time-frequency resources is a different time-frequency resource in a different slot, and at least two slots are associated with different durations; and
communicating with the network node based on the set of time-frequency resources and the off-slot grid communication.

14. The method of claim 13, wherein the set of time-frequency resources corresponds to at least one of a time offset in relation to a slot, a frequency offset, a carrier frequency, a subcarrier spacing (SCS), or a bandwidth.

15. The method of claim 13, wherein the set of time-frequency resources is identified based on at least one of a radio network temporary identifier (RNTI) of the UE, a slot index, a physical broadcast channel (PBCH) index, or at least one key number.

16. An apparatus for wireless communication at a network node, comprising:
a memory; and
at least one processor coupled to the memory and, based at least in part on information stored in the memory, the at least one processor is configured to:
identify a set of time-frequency resources for off-slot grid communication with a user equipment (UE), wherein based on the off-slot grid communication, each of the set of time-frequency resources is a different time-frequency resource in a different slot, and at least two slots are associated with different durations; and
communicate with the UE based on the set of time-frequency resources and the off-slot grid communication.

17. The apparatus of claim 16, wherein the set of time-frequency resources corresponds to at least one of a time offset in relation to a slot, a frequency offset, a carrier frequency, a subcarrier spacing (SCS), or a bandwidth.

18. The apparatus of claim 16, wherein the set of time-frequency resources is identified based on at least one of a radio network temporary identifier (RNTI) of the UE, a slot index, a physical broadcast channel (PBCH) index, or at least one key number.

19. The apparatus of claim 16, the at least one processor being further configured to:
transmit an indication of the set of time-frequency resources to the UE via radio resource control (RRC) signaling.

20. The apparatus of claim 16, wherein the set of time-frequency resources is preconfigured.

21-30. (canceled)
